(19) United States
(12) Patent Application Publication
(10) Pub. No.: US 2016/0151862 A1
(43) Pub. Date: Jun. 2, 2016

(54) Device for laser processing of a surface of a workpiece or for post-treatment of a coating on the outside or the inside of a workpiece

(71) Applicant: LIMO PATENTVERWALTUNG GMBH & CO. KG, Dortmund (DE)

(72) Inventors: Paul Alexander HARTEN, Essen (DE); Peter BRUNS, Recke (DE); Vitalij LISSOTSCHENKO, Froendenberg (DE); Thomas MITRA, Dortmund (DE)

(21) Appl. No.: 14/377,346

(22) PCT Filed: Feb. 11, 2013
(86) PCT No.: PCT/EP2013/052653

§ 371 Date: Aug. 7, 2014

(30) Foreign Application Priority Data
Feb. 10, 2012 (DE) 10 2012 002 487.8
Jul. 18, 2012 (DE) 10 2012 014 209.9

(51) Int. Cl. B23K 26/352; C23C 4/134; C23C 4/129; B23K 26/06; B23K 26/08

(52) U.S. Cl. CPC B23K 26/352; B23K 26/06; B23K 26/08; C23C 4/129; C23C 4/134

(57) ABSTRACT

The invention relates to a device for the processing of a surface of a workpiece or for the post-treatment of a coating on the outside or the inside of a workpiece, in particular a metal workpiece, preferably a tube, comprising a processing head (2) that can be moved through the workpiece or outside of the workpiece, an optical fiber (5), an arrangement for feeding laser light (10) to the processing head (2) or means for producing laser light in the processing head (2), and optical arrangement (7) arranged in the processing head, which can apply the laser light (10) to the inside or the outside of the workpiece.

The present invention relates to a device for processing a surface of a workpiece or for post-treatment of a coating on the outside or the inside of a workpiece, particularly of a metal work piece, preferably of a tube. The invention further relates to a method for processing of a surface of a workpiece or for post-treatment of a coating on the outside or the inside of a workpiece, in particular by using a device of the aforementioned type. The invention further relates to a method for coating the outside or the inside of a workplace.

The work piece can in particular be made of metal or can include metal. Furthermore, the work piece can in particular have a cylindrical shape, for example in the shape of a tube or a rod. The coatings to be processed using the invention can thereby include, for example, at least one layer produced with high-speed flame spraying or plasma spraying or a layer applied by spraying, by wetting or by brushing.

Such coatings are often used as anti-corrosion and anti-wear coatings. The coatings must typically be thermally post-processed in order to achieve a conversion of the applied powdered material into a solid to achieve coherent layer. The treatment of a coating arranged inside a tube proves to be particularly complex.

The problem forming the basis for the present invention is to devise a device of the aforementioned type, which can effectively post-treat a coating arranged in particular in the interior of a tube, or can effectively process a surface of a workpiece. In addition, methods for processing a surface of a workpiece or for post-treatment of a coating disposed on the outside or the inside of a workpiece as well as for coating of the outside or the inside of a workpiece.

This is attained according to the invention with a device having the features of claim 1 and with the methods having the features of claims 16 and 18. The dependent claims relate to preferred embodiments of the invention.

According to claim 1, the movable device includes a processing head that can be moved through the workpiece or outside the workpiece, an optical fiber for supplying laser light to the processing head, or means for generating laser light in the processing head, as well as an optical arrangement in the processing head, which can expose the inside or the outside of the workpiece to the laser light. Through the exposure to laser radiation, a surface of a workpiece can be effectively processed or the coating can be effectively processed, wherein in particular melting of coating constituents to, on or in the surface of the underlying workpiece can be realized.

A device according to the invention or a method according to the invention does not only allow processing of coatings, but also of uncoated metal surfaces. A device according to the invention makes it possible to also rework polished and/or ground metal surfaces much like coatings that were pre-treated by using other methods, such as mechanical machining, chemical cleaning/etching by immersing the workpiece in a solution or brushing the workpiece with a solution, mechanical grinding/polishing by mechanical grinding and/or polishing tools.

When processing metal surfaces, these surfaces may be melted or specifically heated to below the melting point. In the case of melting, the surface tension acting on the surface smoothes the surface with achievable roughness values Ra<0.5 μm. When heating below the melting point, a specific structural change takes place at the surface of the workpiece within the heat-affected zone. Such structural changes are known in various forms, for example as annealing, sintering or hardening.

The latter forms (annealing, sintering, hardening) as well as smoothing of a molten surface can likewise be used for the laser post-treatment of coatings.

For example, the processing head may be moved in the axial direction, like a pig known from other technical fields, through the interior of the workpiece constructed especially as a tube.

The optical arrangement may also include a component which is constructed such that the laser light is deflected inside the component through internal reflection and/or refraction and can then reach the outside or the inside surface of the workpiece to be processed or post-processed. Such a component can be much more easily adjusted and produced than, for example, a reflective component having outside surfaces at which the laser light is reflected to the interior tube walls.

The optical arrangement may be designed such that they can produce a ring-shaped intensity distribution of the laser light on the inside surface or the outside surface of the workpiece formed for example as a tube. This ring-shaped intensity distribution can be obtained by moving of the processing head in the axial direction along the inside or the outside of the tube, which allows the coating to be exposed to laser light very quickly.

The optical arrangement may include a homogenizing means in the form of, for example, a rotationally symmetrical component and in particular a lens array having concentrically or coaxially arranged lenses. With such a component, the laser light can be optimally formed and homogenized for the ring-shaped intensity distribution.

In contrast to the well-established and well-known laser processes (small spot, movement of the laser spot for two-dimensional processing by movable mirrors), the method claimed in the present application is characterized in particular by achieving a heat-affected zone with a uniform distribution, and by being “seamless”. Seamless with respect to the workplace means that no thermal stresses occur along the surface or along the coating on the workpiece during the laser treatment, which could otherwise produce cracks in the surface or in the coating. In addition, the protrusions of material or “beads” known from the conventional overlay-welding are avoided by the invention. This difference between the invention and the conventional laser method occurs because the laser radiation produced by a device according to the invention moves evenly across the surface of the workpiece, thereby minimizing edge effects. When using a device according to the invention, large temperature differences in a small space occur on the workpiece surface only in the feed direction, whereas in the classical laser treatment with a small spot large temperature differences occur in all directions along the surface which can then cause stresses.

The optical arrangement may be designed such that the intensity distribution of the laser light at the front side, toward which the intensity distribution moves, has a different edge shape than at the back side. Here, the edge shape of the intensity distribution at the front side may be optimized for material that has not yet been irradiated, whereas the edge shape of the intensity distribution at the rear side may be optimized for already irradiated material.

The angle of incidence for irradiating the workpiece may not be exactly 90°, thus advantageously preventing back-reflections into the laser light source(s).

Other features and advantages of the present invention will be apparent from the following description of preferred exemplary embodiments with reference to the accompanying drawing, which shows in:

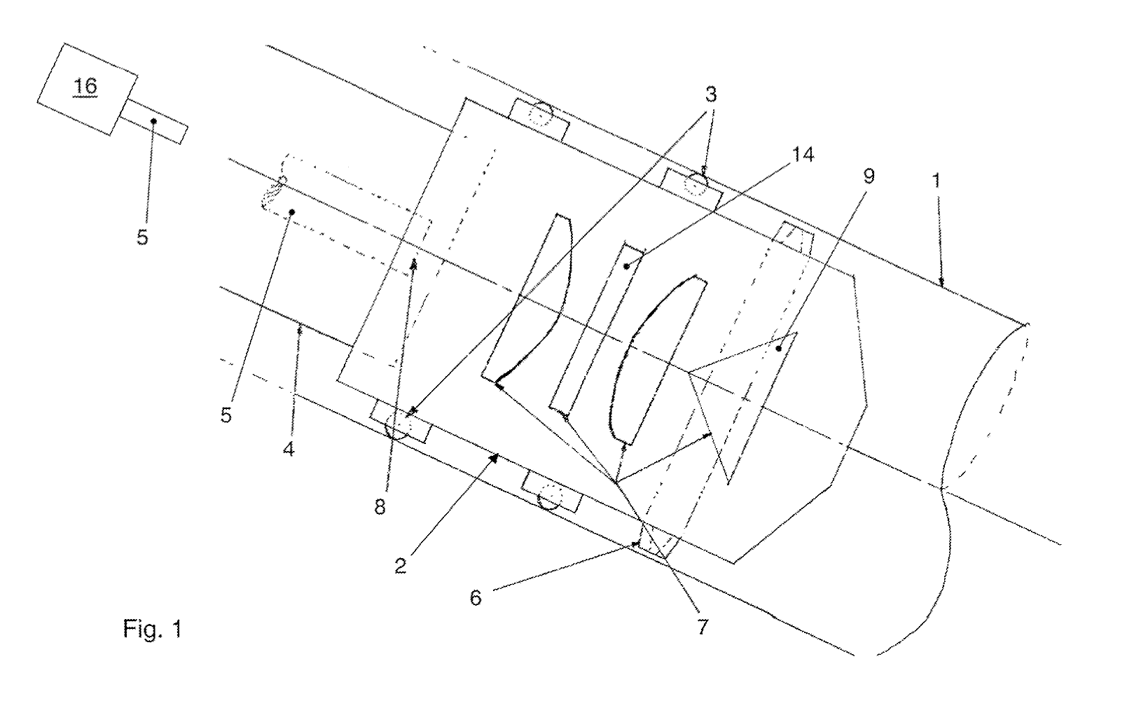

FIG. 1 a schematic sectional view through a tube with a partially shown first embodiment of a device according to the invention;

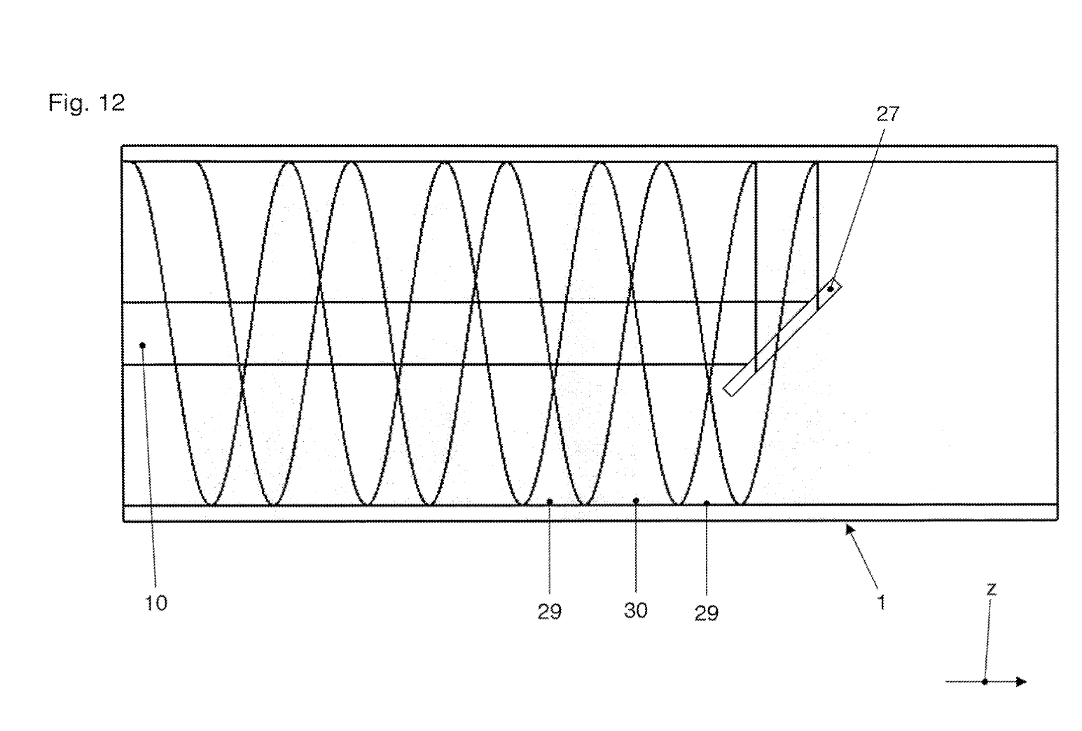

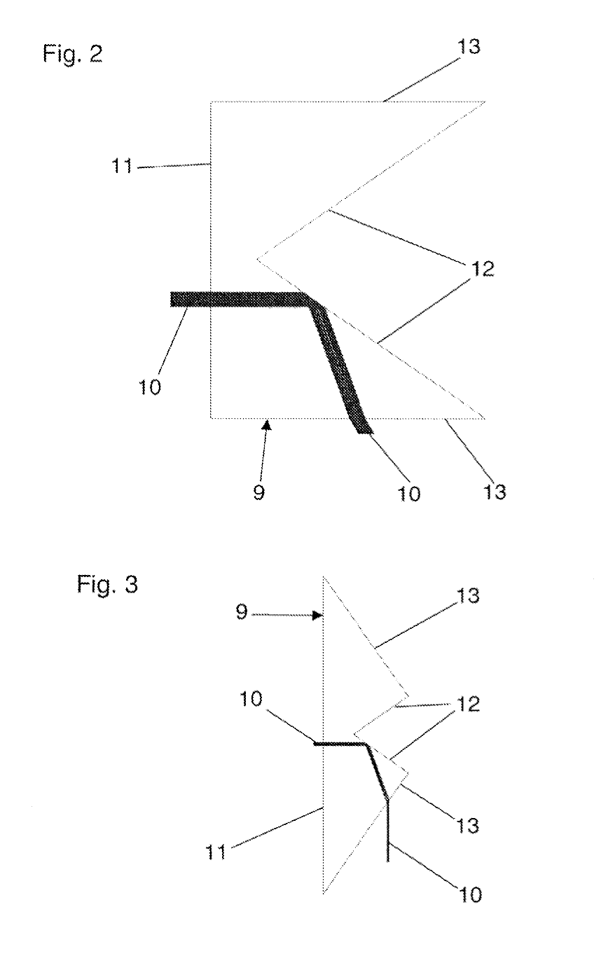

FIG. 2 a schematic sectional view of a second embodiment of a component of the optical arrangement of a device according to the invention with an exemplary laser beam;

FIG. 3 a schematic sectional view of a third embodiment of a component of the optical arrangement of a device according to the invention with an exemplary laser beam;

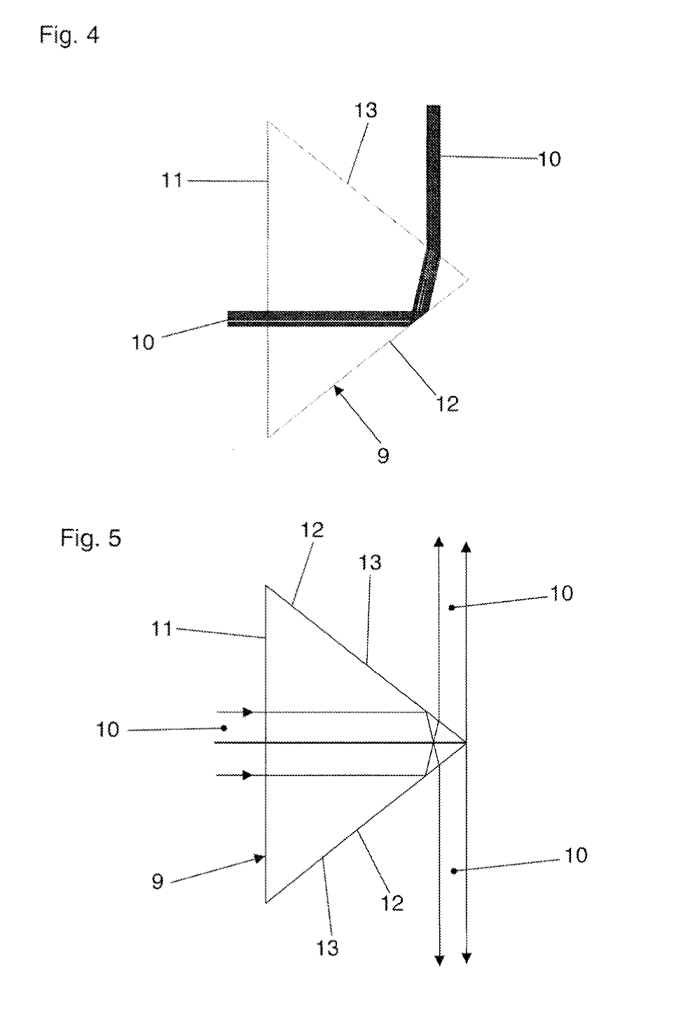

FIG. 4 a schematic sectional view of a fourth embodiment of a component of the optical arrangement of a device according to the invention with an exemplary laser beam;

FIG. 5 a schematic sectional view corresponding to FIG. 4 of the fourth embodiment with a wider laser beam;

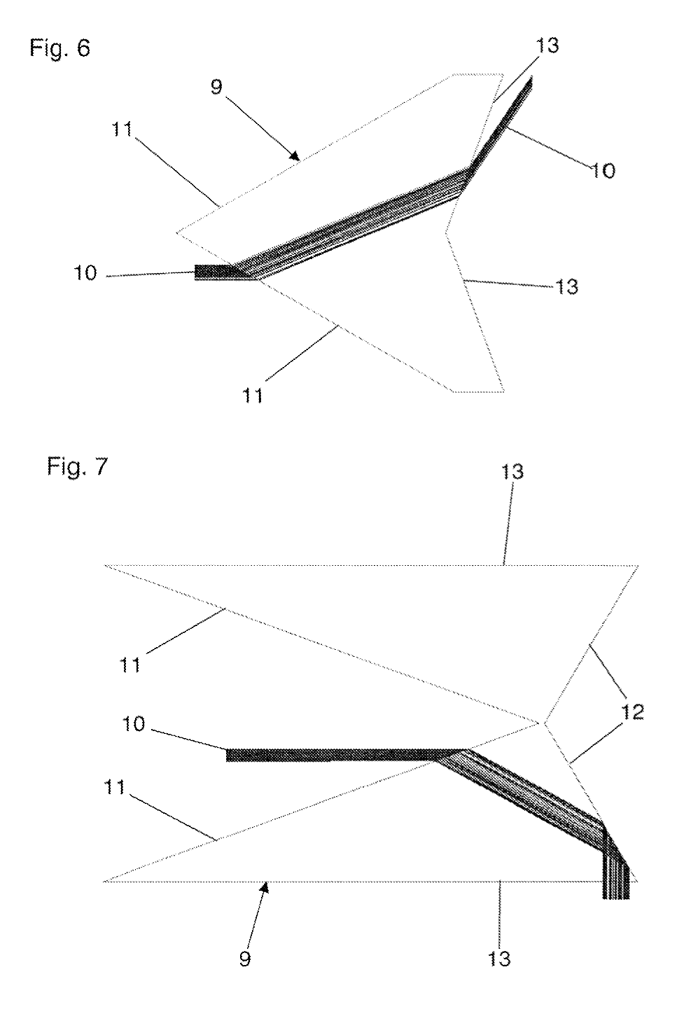

FIG. 6 a schematic sectional view of a fifth embodiment of a component of the optical arrangement of a device according to the invention with an exemplary laser beam;

FIG. 7 a schematic sectional view of a sixth embodiment of a component of the optical arrangement of a device according to the invention with an exemplary laser beam;

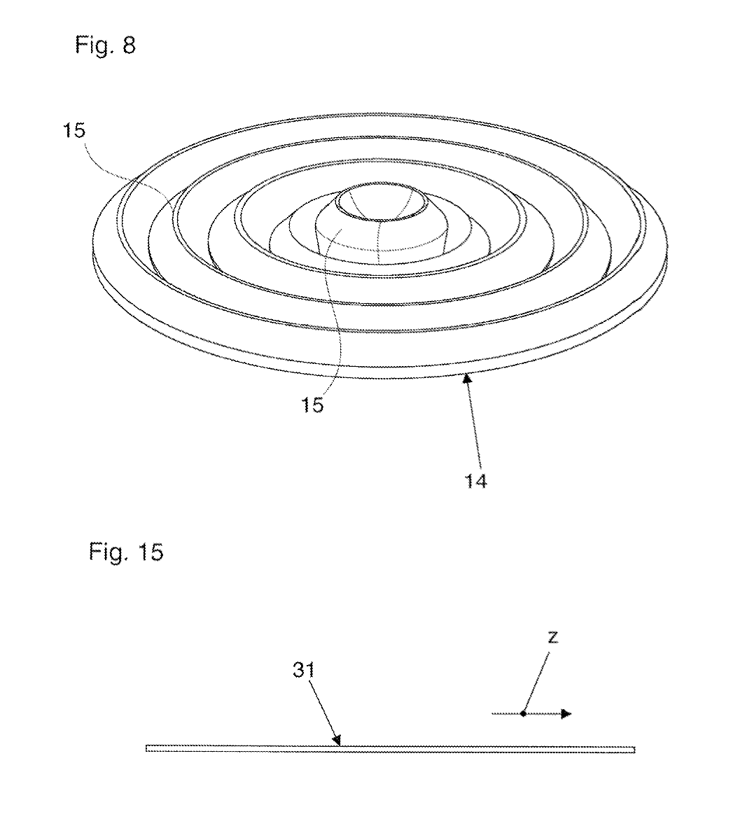

FIG. 8 a perspective view of a homogenizer;

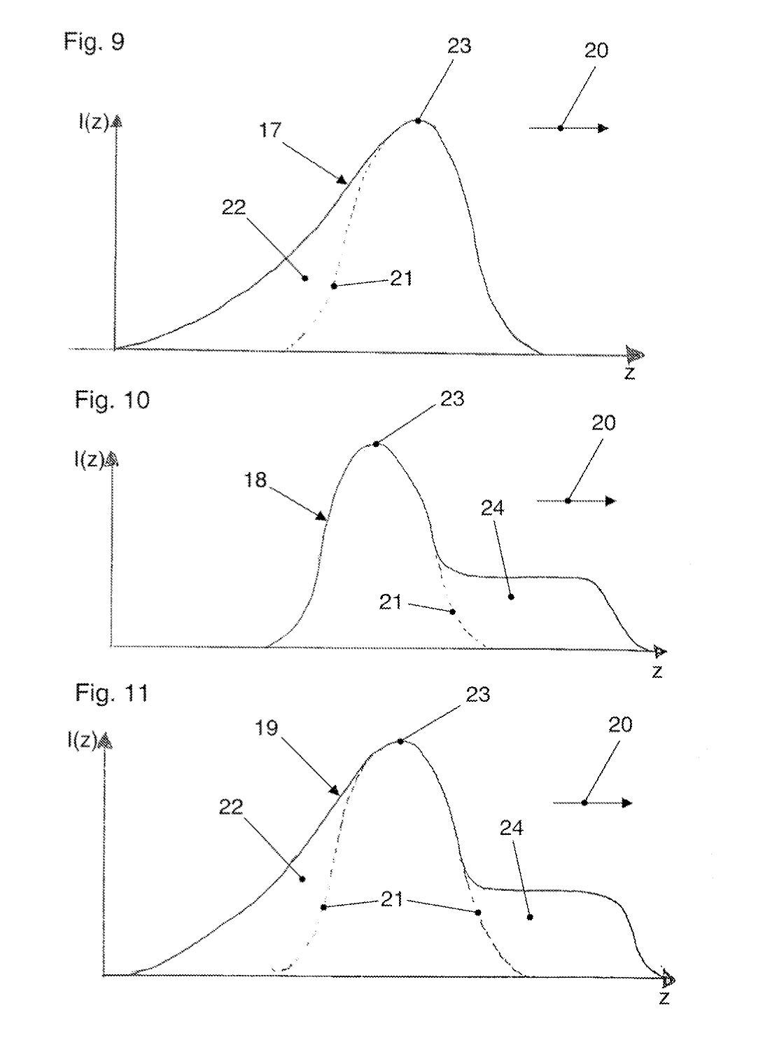

FIG. 9 a schematic representation of (I(z)/z) of a first intensity distribution of the laser light on the workpiece;

FIG. 10 a schematic representation of (I(z)/z) of a second intensity distribution of the laser light on the workpiece;

FIG. 11 a schematic diagram of (I(z)/z) of a third intensity distribution of the laser light on the workpiece;

FIG. 12 a schematic sectional view through a tube with a partially shown second embodiment of a device according to the invention;

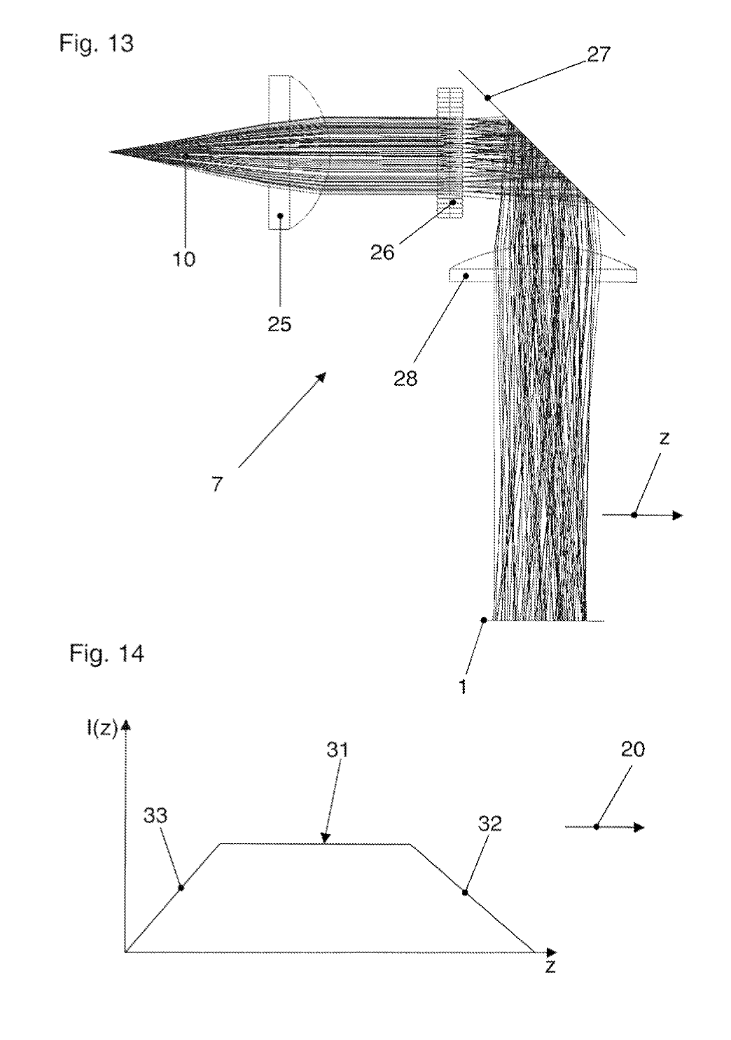

FIG. 13 a schematic diagram of an optical structure of the device of FIG. 2;

FIG. 14 a schematic diagram of (I(z)/z) of a fourth intensity distribution of he laser light on the workpiece;

FIG. 15 an exemplary diagram of a line-shaped intensity distribution.

In the drawings, like or functionally equivalent parts are given the same reference symbols.

In the embodiment according to FIG. 1, a coating composed, for example, of a powdered material was applied on the inside of a tube 1. In particular, this may be a coating applied by high-velocity flame spraying. In particular, this coating may include Al₂O₃. For example, the coating may have a thickness of several 100 μm.

The coating on the inside of the tube 1 is now to be treated with the device according to the invention. This can be achieved in particular by exposing the coating to laser radiation. The coating can thereby be partially melted, and the individual powdery constituents of the layer can be firmly joined together.

The finished coatings may for example he an anti-corrosion layer or a wear-protection layer. The tube 1 may in particular be made of metal or may include metal.

The device according to the invention includes a laser light source 16 and a processing head 2 which is movable in the interior of the tube 1, in particular movable in the axial direction. The laser light source 16 is only schematically illustrated and in particular is not to scale, in conjunction with a connected optical fiber 5, which is also not shown to scale. Laser light within the context of the present application should be understood as referring not only to visible light, but to any type of laser radiation, for example also infrared radiation or UV radiation.

In the illustrated embodiment, the outside of the processing head 2 includes guide rollers 3, which may contact the inside of the tube 1. The processing head 2 is connected to a guide tube 4, which can be used to supply to the processing head 2 the laser light from an external laser light source via an optical fiber 5. Alternatively, a laser light source may also be provided in or on the processing head 2.

The guide tube 4 may also be used for moving the processing head 2 through the tube 1, in particular for moving the processing head 2 into the tube 1 and for pulling the processing head 2 out of the tube 1. Furthermore, at least one duct for process gases may be passed through the guide tube 4, for example, when the post-treatment of the coating is to be performed under a protective gas atmosphere. FIG. 1 shows nozzles 6, in particular ring-shaped nozzles 6, for discharging the process gas.

Optical arrangement 7 are arranged in the processing head 2, which are able to shape the laser light exiting the end 8 of the optical fiber 5 and deflect the laser light to the inside of the tube 1. For example, the optical arrangement include a cone-shaped component 9 which is in particular mirror-coated on the outside and can hence deflect the laser light outwardly to the inside of the tube 1, thereby generating a ring-shaped intensity distribution of the laser light. This ring-shaped intensity distribution can be moved by moving the processing head 2 in the axial direction along the inside of the tube 1, so that the coating can be very effectively exposed to laser light.

The direction of movement of processing head 2 and thus the intensity distribution in the axial direction can be selected commensurate with the application. For example, the processing head 2 can be moved to the right in FIG. 1 or to the left in FIG. 1. A criterion for the direction of movement may be, for example, whether the coating on the inside of the tube 1 is stable enough prior to the irradiation, in order to come into contact, for example, with the guide rollers 3.

Additional rotationally symmetrical members 9 that are not mirror-coated on the outside are shown in FIGS. 2 to 7. The FIGS. 2 to 4 and the FIGS. 6 and 7 each show only a portion of the laser light 10 which is incident off-center and is thus deflected to only one side. Conversely, FIG. 5 shows the incidence of a wide laser beam 10 that is symmetric in relation to the optical axis or the axis of symmetry of component 9 and is deflected radially outwardly in a circular shape. This is evident in FIG. 5 from the fact that a portion of the laser light 10 is deflected both downward and upward.

In the exemplary embodiments according to FIGS. 2 to 5, the incident laser light 10 enters the component 9 through a flat surface 11 that is oriented perpendicular to the laser light 10, undergoes thereafter a total internal reflection on another surface 12, and exits through still another surface 13. Due to the rotational symmetry of the component 9, a ring-shaped intensity distribution of the laser light 10 is formed on the inside of the tube 1.

In the exemplary embodiment shown in FIG. 2, the laser light 10 is deflected by an overall angle of about 75°. In the exemplary embodiments shown in FIGS. 3 to 5, the laser light 10 is deflected by an overall angle of approximately 90°.

In the embodiments shown in FIGS. 6 and 7, the laser light 10 enters a flat surface 11 that is inclined relative to the direction of incidence of the laser light 10. In the embodiment shown in FIG. 6, the laser light exits from the component 9 through a surface 13 without an internal reflection. In the embodiment of FIG. 7, the laser light 10 experiences an additional total internal reflection at a surface 12 and exits through a surface 13.

In the exemplary embodiment shown in FIG. 6, the laser light 10 is deflected by an overall angle of approximately 55°. In the exemplary embodiment shown in FIG. 7, the laser light 10 is deflected by an overall angle of approximately 90°.

The optical arrangement 7 may furthermore include at least one homogenizer 14, which for generating the desired ring-shaped intensity distribution may be composed of a lens array with concentrically or coaxially arranged lenses 15 (see the exemplary embodiment in FIG. 8). Such a homogenizer 14 may be designed so that the exiting angular distribution of the laser radiation has an M-shaped profile. A similar lens array is described in WO 2012/095 422 A2 described.

FIGS. 9 to 11 show possible exemplary intensity distributions 17, 18, 19 of the laser light 10 on the inside of the tube 1. Here, the axial direction z is always shown to the right, so that the diagrams show the profile of the laser radiation in the transverse direction of the ring. The arrow 20 always designates the advance direction of the intensity distribution on the inside of the tube 1.

With the intensity distribution 17 shown in FIG. 9, a controlled post-heating of the coating can be achieved. The broken line 21 indicates an exemplary Gaussian profile. The intensity distribution 17 deviates from such a profile through a region 22 that increases the rear edge of the distribution, thereby attaining after the intensity maximum 23 a phase of longer post-heating.

A controlled pre-heating of the coating can be achieved with the intensity distribution 18 shown in FIG. 10. The broken line 21 again illustrates an exemplary Gaussian profile. The intensity distribution 18 deviates from such a profile through a region 24 that raises the front edge of the distribution, thereby attaining before the intensity maximum 23 a phase of longer post-heating.

The intensity distribution 19 shown in FIG. 11 is an exemplary combination of the intensity distributions 17, 18. Both a controlled pre-heating as well as a controlled post-heating of the coating can therefore be achieved with the intensity distribution 19 shown in FIG. 11.

Furthermore, other optical arrangement may be provided that are capable of producing a line-shaped or a dot-shaped intensity distribution of the laser light on the inside of the tube 1. In this case, the line-shaped or a dot-shaped intensity distribution of the laser light can be moved in a circumferential direction over the inside of the tube by way of a rotational movement of the processing head 2 or of the optical arrangement or of the tube 1.

An example of such embodiments is shown in FIGS. 12 and 13. FIG. 13 shows the optical configuration in which the optical arrangement 7 include a collimating lens 25, a preferably uniaxial two-stage homogenizer 26, a mirror 27 and a Fourier lens 28.

The optical arrangement 7 may generate a line-shaped angular distribution of the laser light 10, with the longitudinal direction of the line extending in the radial direction of the tube 1. Furthermore, the mirror 27 which is inclined relative to the axial direction of the tube 1 at an angle of for example 45° may apply the line-shaped intensity distribution of the laser light 10 to the inside of the schematically indicated tube 1. Here, the mirror 27 together with the homogenizer 26 can be rotated about the axial direction, and optionally also in conjunction with the other optical arrangement 7.

With the mirror 27, a line-shaped intensity distribution extending in the axial direction Z is applied to the inside of the tube 1, which is moved on the inside of the tube 1 in a spiral pattern due to the rotation of the mirror or of the optical arrangement 7 and the advance of the processing head 2. FIG. 12 schematically illustrates this spiral movement, wherein the spiral has been stretched for sake of clarity, thereby identifying non-irradiated regions 30 between the individual irradiated regions 29. This structure is merely illustrative. Of course, in practice, the inside of the tube 1 can be exposed to the laser light 10 without gaps or, preferably, with an overlap.

FIG. 14 shows in form of an example a possible intensity distribution 31 of the laser light 10 on the inside of the tube 1 as a function of z. The axial direction z is here depicted to the right, so that the diagrams show the profile of the laser radiation in the longitudinal direction of the line-shaped intensity distribution. The arrow 20 again indicates the advance direction of the intensity distribution 31 on the inside of the tube 1.

FIG. 14 shows dearly that even with the line-shaped intensity distribution 31, the edge 32 that irradiates the unprocessed material and the edge 33 that illuminates already irradiated material can be designed differently. The design can also be adapted to the particular thermal properties of the sample and the rotation speed of the line.

FIG. 15 shows again the linear intensity distribution 31 in plan view. The diagram schematically indicates that the beam cross-section has a much larger extent in the z direction (from left to right in FIG. 15) than in the direction perpendicular thereto (from top to bottom in FIG. 15) which corresponds to the circumferential direction of the tube 1.

The device according to the invention may also be used for post-treatment of coatings disposed on the inside of non-tubular workpieces. Furthermore, the outside surfaces of workpieces can also be post-treated with the device according to the invention.

For example, a circumferential ring-shaped intensity distribution of the laser radiation can be generated on the outside of a cylindrical workpiece, which may be a tube as well as a rod. This “outer laser ring” can then be moved along the cylindrical workpiece in the axial direction.

Examples of preferred implementations of surfaces to be processed are polished and/or ground metal surfaces.

The laser radiation used in the treatment of the surface or in the treatment of the coating may have a wavelength between 192 nm and 10,700 nm. Furthermore, the laser radiation used for processing of the surface or for treatment of the coating may have an optical power between 300 W and 300 kW. Moreover, the laser beam used for processing of the surface or for treatment of the coating may have an intensity between of 6 kW/cm² and 1000 kW/cm².

Furthermore, the line focus of the laser beam used for processing of the surface or for treatment of the coating may extend in the long axis between 1 mm and 6000 mm. Furthermore, the line focus of the laser beam used for processing of the surface or for treatment of the coating may extend in the short axis between 50 μm and 5 mm.

The relative velocity between the workpiece surface and the laser beam may be between 1 mm/s to 1000 mm/s.

In general, the shape of the edge of the intensity distribution of the laser light at the front side, in which the intensity distribution moves in the axial direction of the tube 1, may be different from the shape of the edge at the rear side. Here, the shape of the edge of the intensity distribution on the front side may be optimized for material that has not yet been irradiated, while the shape of the edge of the intensity distribution may be optimized for already irradiated material.

1-18. (canceled)

19. A device for processing of a surface of a workpiece or for post-treatment of a coating on the outside or the inside of a workpiece, in particular of a metal workpiece, preferably of a tube, comprising
a processing head (2) configured to be movable through the workpiece or outside the workpiece,
an optical fiber (5) for supplying laser light (10) to the processing head (2) or means for generating of laser light in the processing head (2),
an optical arrangement (7) disposed in the processing head (2) and configured to apply the laser light (10) to the inside or the outside of the workpiece.

20. The device according to claim 19, wherein the optical arrangement (7) comprise a component (9) that is designed such that the laser light (10) is deflected inside the component (9) by internal reflection and/or refraction, so that the laser light (10) reaches the outside or inside of the workpiece to be processed or post-treated.

21. The device according to claim 20, wherein the component (9) is a rotationally symmetrical component.

22. The device according to claim 19, wherein the optical arrangement (7) is designed such that the optical arrangement is capable of generating a ring-shaped intensity distribution of the laser light (10) on the inside of the workpiece formed in particular as a tube (1) or on the outside of the workpiece formed in particular as a cylinder.

23. The device according to claim 19, wherein the optical arrangement (7) comprises a homogenizer.

24. The device according to claim 23, wherein the homogenizer (14) is a rotationally symmetrical component and comprises in particular a lens array with concentrically or coaxially arranged lenses (15).

25. The device according to claim 19, wherein the optical means (7) are constructed so as to be able to generate a line-shaped intensity distribution (31) of the laser light (10) on the inside or the outside of the workpiece, wherein the line-shaped intensity distribution (31) extends in particular in the axial direction (z) of the workpiece and is moveable in form of a spiral across the inside of the workpiece formed in particular as a tube (1).

26. The device according to claim 19, wherein the optical means (7) are designed such that the intensity distribution of the laser light (10) at the front side, in the movement direction of the intensity distribution, has a different shape of the edge than at the back side.

27. The device according to claim 19, wherein the processing head (2) is moveable in the axial direction through the tube (1) or outside of the cylindrical workpiece.

28. The device according to claim 19, wherein the processing head (2) comprises means for supplying process gas, in particular at least one nozzle (6).

29. The device according to claim 19, wherein the device comprises at least one laser light source (16) for generating laser light (10), whereby the laser light (10) emitted from the laser light source (16) is being supplied to the processing head (2) in particular via the optical fiber (5).

30. The device according to claim 19, wherein the device comprises a guide tube (4) connected to the processing head (2), wherein the guide tube (4) is used to move the processing head (2) relative to the workpiece.

31. The device according to claim 30 wherein the optical fiber (5) extends through the guide tube (4).

32. The device according to claim 19, wherein the outside guide means are guide rollers (3).

33. The device according to claim 19, wherein the coating is a thermally sprayed coating.

34. A method for processing of a surface of a workpiece or for post-treatment of a coating on the outside or the inside of a workpiece according to claim 19, comprising the steps of:
providing a processing head (2), preferably moveable in the axial direction through the workpiece or outside the workpiece;
generating a laser light (10) applied by the processing head (2) to the inside or the outside of the workpiece for processing the surface of the workpiece, or for post-treatment of the coating.

35. The method according to claim 34, further providing a ring-shaped intensity distribution of the laser light (10) on the inside of the workpiece that is formed in particular as a tube (1) or on the outside of the workpiece that is formed in particular as a cylinder.

36. The method for coating the outside or the inside of a workpiece, comprising the steps of:
applying a coating on the inside or the outside of the workpiece, in particular by high-speed flame spraying;
the coating is post-treated by a method according to claim 34.

37. The device according to claim 25, wherein workpiece is cylindrical.

38. The device according to claim 28, wherein the gas is supplied by a nozzle.

39. The device according to claim 29, wherein the supply to the processing head (2) is accomplished via the optical fiber (5).

40. The device according to claim 33, wherein the coating is applied by high-speed flame spraying or plasma spraying, or the coating is applied by spraying, by wetting and brushing.
